(19) United States
(12) Patent Application Publication
(10) Pub. No.: US 2012/0015175 A1
(43) Pub. Date: Jan. 19, 2012

(54) COATING MATERIALS FOR BISPHENOL A-CONTAINING POLYMERS

(76) Inventors: Toshimi Fukui, Ohtsu City (JP); Motoyuki Toki, Kyoto-shi (JP)

(21) Appl. No.: 13/123,597

(22) PCT Filed: Jun. 29, 2010
(86) PCT No.: PCT/US10/40409

§ 371 Date: Apr. 11, 2011

(51) Int. Cl. B32B 5/16; B32B 27/00; B32B 27/38; B32B 9/04

(52) U.S. Cl. 428/323; 428/411.1; 428/412; 428/413; 428/421; 428/500

(57) ABSTRACT

The present technology provides compositions that may be coated on bisphenol A-containing polymers to provide a coating or film that prevents bisphenol A from leaching from the polymer. Coatings using the present compositions also protect the bisphenol A-containing polymer from degradation by UV rays and other sources. The compositions include one or more matrix polymers having a solubility parameter of about 20 or less; and a plurality of UV-blocking nanoparticles dispersed in the one or more matrix polymers; wherein the composition is substantially free of bisphenol A. Methods of making the compositions and coatings are also provided. The coatings may be used on food and beverage containers made from bisphenol A-containing polymers.

### BACKGROUND

Bisphenol-A (BPA) is a common chemical that is an inexpensive precursor molecule for polymers and resins used widely in consumer and medical applications. The primary use of bisphenol-A is to create polymers including epoxy resins, polyurethane, polyacrylate, and polycarbonate. The aromatic moieties of bisphenol-A are highly ridged leading to polymers with great mechanical strength and high glass transition temperatures.

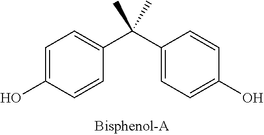

Bisphenol-A based polymers and resins are found in a wide range of products and applications, from consumer products to medical equipment. For example, bisphenol-A based epoxy resins are commonly used for coil and can coatings; bisphenol-A based polycarbonates and their copolymers are used to produce food containers including baby bottles, tableware, water bottles; and bisphenol-A based polymers are used in medical devices including renal dialysis devices, cardiac surgery products, surgical instruments, and Intravenous connection components.

The main drawback to bisphenol-A based polymers is that they are susceptible to degradation and yellowing upon exposure to light. Upon degradation of the polymers, BPA leaches into the contents of the food and beverage containers or medical storage devices. As BPA and estradiol (the major component of the estrogen family) have similar structural features, it has been suggested that bisphenol-A mimics estrogen behavior in the body. (See, e.g., Sekizawa, J. J. Toxicol. Sci. 33(4), 389 (2008); Oehlmann, J. et al. Environ. Res. 108(2), 140 (2008); Mandich, A. et al. Gen. Comp. Endocr. 153(1-3), 15 (2007).) Indeed, BPA appears to behaves as an endocrine disruptor. The hormonal behavior of BPA has a wide range of consequences including causing birth defects, miscarriages, neurological problems, menstrual cycle disruptions, testicular disruption, breast growth in males and more. (See, e.g., Vandenberg, L. N. Repro. Toxicol. 24, 139 (2007); Welshon, W. V., et al. Endocrinology 147(6), s56 (2006); and vom Saal, F. Endocrinology 147(8), 3679 (2006).)

### SUMMARY

The present technology provides compositions of materials that may be used as coatings for polymers containing bisphenol A (BPA). The present compositions, when coated over a BPA-containing polymer on a food or beverage container, blocks the leaching of BPA into the contents of the container. Further, the present compositions block ultraviolet (UV) rays from reaching the BPA-containing polymer and inhibit degradation of such polymers by, e.g. exposure to sunlight or other sources of UV rays.

Accordingly, in one aspect, the present technology provide a composition including: one or more matrix polymers having a solubility parameter of about 20 or less; and a plurality of UV-blocking nanoparticles dispersed in the one or more matrix polymers; wherein the composition is substantially free of bisphenol A.

In some embodiments of the composition, the matrix polymer is a hydrocarbon polymer, a polyglycol polymer, a fluorine-containing polymer or a mixture of two or more thereof. In some embodiments, the hydrocarbon polymer is polyethylene, polypropylene, polyisobutylene, polycycloolefin, polybutadiene, polyisoprene, or a mixture of two or more thereof. In some embodiments, the polyglycol polymer is polytetramethylene oxide, polypropylene oxide, or a mixture of two or more thereof. In some embodiments, the fluorine-containing polymer is polytetrafluoroethylene. In some embodiments, the one or more matrix polymers include one or more types of hydrophilic functional groups. In some embodiments, the type of hydrophilic functional group is a carboxyl group, an amino group or a mixture thereof.

In some embodiments, the nanoparticles have an absorbing edge wave length from about 350 nm to about 400 nm. In some embodiments, the nanoparticles are titanium oxide, cerium oxide, zinc oxide, tin oxide, aluminum oxide or a mixture of any two or more thereof. In some embodiments, surfaces of the nanoparticles include a surface modification agent. In some embodiments, the surface modification agent is selected from the group consisting of alkylsilane, alkenylsilane, and alkoxysilane. In some embodiments, the plurality of nanoparticle include about 50 wt % of the composition or less. In some embodiments, the average diameter of the nanoparticles is about 50 nm or less.

In some embodiments of the present compositions, the one or more matrix polymers are selected from the group consisting of polyethylene, polypropylene and copolymers thereof; and the nanoparticles include a surface modification agent and are selected from the group consisting of titanium oxide, cerium oxide, zinc oxide, and tin oxide nanoparticles.

In another aspect, the present technology provides a coating or film comprising any of the compositions disclosed herein.

In another aspect, the present technology provides an article of manufacture comprising a polymer comprising bisphenol A, wherein at least a portion of the polymer is coated with any of the compositions disclosed herein. In some embodiments of the article of manufacture, the polymer is a polycarbonate or an epoxy resin. In some embodiments, the article is a food or beverage container.

In another aspect, the present technology provides methods of manufacturing the compositions disclosed herein. The methods include combining one or more matrix polymers having a solubility parameter about 20 or less, one or more solvents, and a plurality of UV-blocking nanoparticles to form a coating solution or slurry substantially free of bisphenol A. The methods further include forming a film or coating with the coating solution on a surface of a polymer including bisphenol A.

In some embodiments of the present methods, the matrix polymer is a hydrocarbon polymer, a polyglycol polymer, or a fluorine-containing polymer. In some embodiments, the hydrocarbon polymer is polyethylene, polypropylene, polyisobutylene, polycycloolefin, polybutadiene, polyisoprene, or a mixture of two or more thereof. In some embodiments, the polyglycol polymer is polytetramethylene oxide, polypropylene oxide, or a mixture of two or more thereof. In some embodiments, the fluorine-containing polymer is polytetrafluoroethylene. In some embodiments, the one or more matrix polymers include one or more types of hydrophilic functional groups. In some embodiments, the type of hydrophilic functional group is a carboxyl group, an amino group or a mixture thereof.

In some embodiments of the present methods, the nanoparticles have an absorbing edge wave length from about 350 nm to about 400 nm. In some embodiments, the nanoparticles are titanium oxide, cerium oxide, zinc oxide, tin oxide, aluminum oxide or a mixture of any two or more thereof. In some embodiments, surfaces of the nanoparticles include a surface modification agent. In some embodiments, the surface modification agent includes alkylsilane. In some embodiments, the plurality of nanoparticle include about 50 wt % of the composition or less. In some embodiments, the average diameter of the nanoparticles is about 50 nm or less.

In some embodiments of the present methods, the one or more matrix polymers are selected from the group consisting of polyethylene, polypropylene and copolymers thereof; and the nanoparticles include a surface modification agent and are selected from the group consisting of titanium oxide, cerium oxide, zinc oxide, and tin oxide nanoparticles.

The foregoing summary is illustrative only and is not intended to be in any way limiting. Hence, it will be understood that any embodiment described above may be combined with any non-mutually exclusive embodiment. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 depicts an illustrative embodiment of a coating or film of the present technology coated on a BPA-containing polymer.

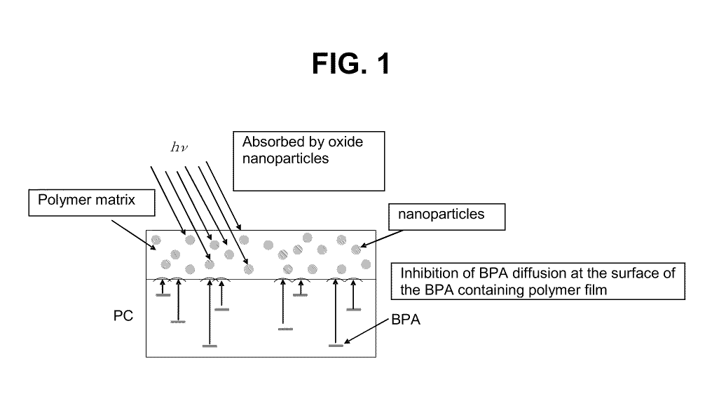

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Compositions of the present technology may be used to protect the surfaces of BPA-containing polymers. Such compositions include one or more matrix polymers having a solubility parameter of about 20 or less; and a plurality of UV-blocking nanoparticles dispersed in the one or more matrix polymers; wherein the composition is substantially free of bisphenol A. When such a composition is coated on a BPA-containing polymer, it will block diffusion of BPA into and through the coating because of the large difference in the solubility parameters between the matrix polymers of the coating and the BPA-containing polymer. As the present compositions are substantially free of BPA, little to no BPA should be leached into, e.g., food or drink stored in containers comprising BPA-containing polymers coated with the present compositions.

Moreover, coatings of the present technology will inhibit degradation of BPA-containing polymers. Conventional polyurethane and methacrylate films used for the protection of BPA-containing polymers are not tough enough to protect BPA-containing polymers from UV deterioration, hydrolysis, and the like, which leads to the release of BPA from the polymer. The nanoparticles of the present compositions absorb UV rays so that little or no UV reaches the BPA-containing polymer, and thus inhibit UV-based degradation of such polymers. In addition, coatings of the present compositions protects the BPA polymer from moisture and heat-induced deterioration over time.

### Composition and Coatings

Compositions of the present technology are composites which include one or more matrix polymers having a solubility parameter of about 20 or less. As used herein, the solubility parameter is a measure of cohesion energy and is calculated according to the method of Fedors (Polymer Engineering and Science, 14:147-54 (1974)): δ=Σ(ΔEᵢ/ΔVᵢ), where ΔEᵢ is the vaporization energy of the i component atom or atomic group, and ΔVᵢ is the molar volume of the i component atom or atomic group. Since the solubility parameter of BPA is about 28 (specifically 27.9 J^{1/2}/cm^{3/2}), and that of the matrix polymer is about 20 or less, the difference in the parameters is too great to allow BPA to diffuse into the matrix polymer. Thus, coatings of the present compositions use the difference in solubility parameters between BPA and the matrix polymers to create a barrier film that blocks leaching of BPA from the BPA-containing polymer.

Matrix polymers useful for the present compositions include hydrocarbon polymers, polyglycol polymers, fluorine-containing polymers, copolymers thereof and mixtures of any two or more thereof. For example, the matrix polymer may be selected from polyethylene (SP: 15.8˜17.1), polypropylene (SP: 16.8˜18.8), polyisobutylene (SP: 16.0˜16.6), polycycloolefin, polybutadiene (SP: 16.6˜17.6), polyisoprene (SP :16.2˜20.5), polytetramethylene oxide (SP: 17.0˜17.5), polypropylene oxide(SP:15.4˜20.3), polytetrafluoroethylene (SP:14.7˜16.2), and the like, as well as mixtures of any two or more thereof. Similarly, copolymers having suitable solubility parameters may also be used such as poly(ethylene)-poly(propylene), polyethylene oxide-polypropylene oxide polymers. Solubility parameters for copolymers may be calculated by taking into account the proportion of each polymer in the copolymer. Matrix polymers including one or more types of functional groups such as carboxyl and amino groups may be used to improve compatibility between the polymers and the nanoparticles. However, the solubility parameter of such polymers may not exceed about 20. For example, polyethyl acrylate (SP: 18.8-19.2), polybutyl acrylate (SP:18.0-18.6), poly 2,2,3,3,4,4,4-heptafluorobutyl acrylate (SP:13.7), polyethyl methacrylate (SP:18.2-18.7), and polybutyl methacrylate (SP:17.8-18.4) may be used. The matrix polymers of the present compositions are substantially free of BPA. By substantially free, it is meant that the polymers contain no significant amount of BPA, e.g., less than 1 ppm.

In the present compositions, the nanoparticles are typically inorganic and may have a high UV light absorption efficiency. Thus, in some embodiments, the nanoparticles have an absorption edge wavelength ranging from about 350 nm to about 425 nm. By “absorption edge wavelength” is meant the wavelength of light about at which a material shows a substantial increase in absorption of shorter wavelengths. For example, titanium dioxide has an absorption edge wavelength of about 400 nm. Nanoparticles that may be used in the present compositions include titanium oxide (e.g., titanium dioxide), cerium oxide (e.g., CeO₂, Ce₂O₃), zinc oxide (ZnO), tin oxide (e.g., SnO or SnO₂), aluminum oxide or mixtures of any two or more thereof.

The amount of nanoparticles dispersed in the matrix polymer(s) may range from about 1 weight percent (wt %) to about 80 wt % of the composition. In some embodiments, the amount can be about 50 wt % or less than 50 wt %. The amount may also be about 40 wt % or less than 40 wt %, about 30 wt % or less than 30 wt %, about 20 wt % or less than 20 wt %. Within this range, the compositions retain good film formation properties as well as good UV blocking properties. The average size of the nanoparticle may be about 50 nm or less, about 40 nm or less, about 30 nm or less, about 20 nm or less, or about 10 nm or less, and may range from about 50 nm to about 1 nm or from about 40 nm to about 1 nm, about 30 nm to about 1 nm, from about 20 nm to about 1 nm or from about 10 nm to about 1 nm. Coatings prepared from such compositions may retain good visible light permeability with nanoparticles in this size range.

Larger particle sizes may also be used in coating materials of the present technology. In some embodiments, the size of the nanoparticle (diameter if it is a sphere, a side length if it is a square, rectangle, tubular, plate, or needle shape) may be up to about one fifth (⅕) of the thickness of the matrix polymer coating. For example the matrix polymer coating may range in thickness from about 100 nm to 500 um and therefore the particle may range from 20 nm to 100 μm. In some embodiments, the thickness of the matrix polymer coating may range from about 100nm-about 500 μm, about 200 nm-about 400 μm, about 300 nm-about 300 μm, about 400 nm-about 250 μm, about 500 nm-about 200 μm, about 600 nm-about 150 μm, about 700 nm-about 100 μm, about 800 nm-about 80 μm, about 900 nm-about 50 μm, about 1 μm-about 30 μm or from about 1 to about 10 μm.

To avoid aggregation of the nanoparticles and increase homogeneity of the nanoparticle dispersion in the matrix polymer(s), the nanoparticles may be surface modified to provide better compatibility with the matrix polymer(s). A suitable surface modification agent may be selected considering the solubility parameters of the matrix polymer(s) and the composition of the nanoparticles. Such surface modification agents include silanes and phosphorous-based agents bearing a suitable group for reacting with the nanoparticle surface (e.g., halo, hydroxy, alkoxy, and the like) and one or more groups compatible with the matrix polymer(s) into which the surface modified nanoparticle will be dispersed. Thus, suitable surface modification agents include, but are not limited to silanes such as alkylsilanes, alkenylsilanes, and alkoxysilanes. Alkyl-, alkenyl-, and alkoxysilanes are silanes having, respectively, at least one alkyl, alkenyl, or alkoxy, group attached directly to the silicon atom. Suitable phosphorous-based surface modifying agents include phosphonates, e.g., RP(O)(OH)₂ and phosphites, e.g., RP(O)(OR′)₂, where R and R′ are independently alkyl at each occurrence. Thus, phosphorous-based agents include alkylphosphonates and alkylphosphites. Surface modification agents utilizing amines, carboxylic acids or alkanols as in U.S. Pat. No. 7,129,277 may also be used. Surface modification agents having phenyl groups should generally be avoided to prevent increasing the solubility of BPA in the matrix polymer.

As used herein, “alkyl groups” have from 1 to 20 carbons and include straight or branched alkyl groups such as, but not limited to methyl, ethyl, propyl, isopropyl, butyl, isobutyl, pentyl, neopentyl, hexyl, heptyl, octyl, isooctyl, nonyl, decyl, undecyl, dodecyl, and so forth. Alkyl groups also include C₃₋₆ cycloalkyl groups (cyclopropyl, cyclobutyl, cyclopentyl, and cyclohexyl) and straight or branched alkyl groups substituted with a C₃₋₆ cycloalkyl group. Alkenyl groups are alkyl groups having one or two carbon-carbon double bonds such as, but not limited to vinyl and propenyl. Phenylalkyl groups are C₁₋₁₄ alkyl groups substituted with a phenyl group, such as, but not limited to, benzyl and phenylethyl groups. Alkyl, alkenyl and phenyl groups also include such groups optionally substituted with halo, mercapto, keto, C₁₋₄ alkoxy, amine and urethane groups.

Surface modifications, especially nonpolar ones, may be made as described in U.S. Pat. No. 7,129,277 and JP2009-185224 (each of which is incorporated by reference herein in their entireties). Examples of silane coupling agents useful as surface-modifying agents include alkylchlorosilanes, alkoxysilanes, e.g., methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, butyltrimethoxysilane, butyltriethoxysilane, hexyltrimethoxysilane, octyltrimethoxysilane, 3-mercaptopropyltrimethoxysilane, n-octyltriethoxysilane, polytriethoxysilane, vinyltrimethoxysilane, vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri(t-butoxy)silane, vinyltris(isobutoxy)silane, vinyltris(isopropenoxy)silane and vinyltris(2-methoxyethoxy)silane; trialkoxyarylsilanes; isooctyltrimethoxy-silane; and polydialkylsiloxanes including, e.g., polydimethylsiloxane; and combinations thereof.

As noted above, the compatibility of the matrix polymer with the nanoparticles may be improved by using polymers having one or more hydrophilic functional groups, such as a carboxylate or amino terminal groups. However, where microwave resistance of the composition is necessary, only the surface modification of the nanoparticles should be used.

### Method for Manufacturing the Coating Material

In another aspect, there are provided methods for manufacturing any of the compositions and coatings disclosed herein. The methods include combining one or more matrix polymers having a solubility parameter about 20 or less, one or more solvents and the UV-blocking nanoparticles to form a coating solution or slurry substantially free of bisphenol A. In some embodiments of the methods, surfaces of the nanoparticles include a surface modification agent. Various solvents may be used to make the coating solution/slurry depending on the type(s) of matrix polymer, including but not limited to hydrocarbons such as toluene, xylene, and tetrahydrofuran (THF), water, ethanol, acetone, dioxane and the like. It will be understood that the nanoparticles may be added to the solvent before, after or simultaneously with the matrix polymer(s) to form the coating solution/slurry.

Nanoparticles suitable for use in the present compositions may be prepared from the inorganic materials and surface modifying agents described above using techniques known in the art including the sol-gel process, the hydrothermal synthesis (Bull. Mater. Sci., Vol 23, No. 6, December 2000, pp. 453-460), metal organic decomposition (Liu, W. L. et al., J. Crystal Growth (2004) 269, 499-504) and the coprecipitation process (Deshpandej, V. V. et al., Bull. Mater. Sci. (2005) 28:3, 205-07; U.S. Pat. No. 4,894,185). Each of these references is hereby incorporated by reference herein.

The present methods further include forming a film or coating with the coating solution on a surface of a polymer comprising bisphenol A. For example, the coating solution may be sprayed onto the surface of a polycarbonate or epoxy polymer material, or the polycarbonate or epoxy polymer material may be dipped into the coating solution (e.g., dip-coating as in U.S. Pat. No. 4,353,934). Other methods such as spin-coating (spinning the surface to be coated until the desired area and thickness of coating are obtained, e.g., as in spin-coating (Journal of ELECTRONIC MATERIALS, Vol. 35, No. 6, 2006; Annu. Rep. Prog. Chem, Sect. C, 2005, 101, 174-201), dip-coating (U.S. Pat. No. 4,353,934), spray coating (U.S. Pat. No. 6,120,354) and sol-gel processing (The Sol-Gel Process as a Basic Technology for Nanoparticle-Dispersed Inorganic-Organic Composites: Journal of Sol-Gel Science and Technology, Volume 19, Numbers 1-3, December 2000) may also be used. The conditions may readily be determined depending on the materials and methods used for the coating.

A wide variety of film thicknesses may be produced on the BPA-containing polymer including, but not limited to about 0.5 μm to about 10 μm, about 1.0 μm to about 8μm, about 1 μm to about 5μm, about 1 μm to about 3 μm, and so forth.

### EXAMPLES

The present technology is further illustrated by the following examples, which should not be construed as limiting in any way.

### Example 1

### Preparation of Nanoparticles of TiO₂ b Sol-Gel Processing

20 wt % (Ti(O-nPr)₄) is dispersed in 5 mass percent propylene glycol a-monomethyl ether (MP; CH₃OCH₂CH(CH₃)OH). Then 5 mass percent phenyl tri-methoxy silane (PTMS) is partially hydrolyzed with 0.1 M (mole/L) HCl and the partially hydrolyzed PTMS is added to the titanium-containing solution (PTMS and Ti-containing solution are equimolar in amount). The sol is then prepared by hydrolysis (H₂O/Ti=1.0 molar) of the product resulting from reaction of titanium alkoxide and the hydrolyzed PTMS. The mixed solution is stirred for 1 hour at the room temperature, and is then stirred and heated for 1 hour at 60° C. Thus, sol is prepared using the solution by first hydrolyzing and then condensation-polymerizing the titanium species. Subsequently, the MP is removed from the sol, and the resulting material is heated at 50° C. and under reduced pressure to provide the surface modified nanoparticles.

### Example 2

### Preparation of a Composition of the Present Technology

The PTMS-TiO₂ prepared in Example 1 and polypropylene are mixed in dioxane to form a solution, and a TiO₂/polypropylene composite is obtained. This coating composition may be applied to a bisphenol-containing polymer such as polycarbonate by any conventional method such as the spray method, dip-coat method, spin-coat method and the like.

### Example 3

### Assay of the Amount of BPA Leaching into Water from Coated Polycarbonate

Three squares of polycarbonate (15 cm×10 cm×10 mm) are each dip-coated with the coating composition of Example 2. After the coating is hardened, the coated squares of polycarbonate are each placed in a separate vessel containing 200 ml distilled water having no detectable BPA. Three controls (untreated squares of polycarbonate) are also placed in individual vessels containing 200 ml distilled water each. The vessels are heated to boiling for 30 minutes. Upon cooling, samples of the water from each vessel are assayed by HPLC for dissolved BPA according to the method of Kawamura, Y.; Sano, H.; Yamada, T. “Migration of bisphenol A from can coatings to drinks” Journal of Food Hygiene Society Japan (1999), 40(158), 165. The analysis is essentially as follows.

A Shimazu HPLC system is used which includes HPLC Pumps: LC-10A; oven: CTD-10Avp; UV-Vis spectrophotometer: SPD-10 AVvp; system controller: SCL-10A, data processor: C-R7Aplus, auto-injector: SIL-10Axl. Additional equipment includes a thermostatic chamber: ST-120, Tabai Espec, Japan; column: TSK gel ODS-80Ts(Internal diameter 4.6 mm, length 250 mm, 5 μm particles), Tosoh, Japan; and guard column:TSK guard gel ODS-80Ts (internal diameter 3.2 mm, length 15 mm), Toso, Japan. The conditions include column temperature: 40° C.; mobile phase: acetonitrile/water (50/50) as initial setting, then linear gradient for 20 min. to 100% acetonitrile; flow rate:1.0 ml/min; wave length for detection: 217 nm; injection volume: 10 μl. Before injection, the samples are filtered using the LCR13-LH filter (Millipore) pore size 0.5 μm, diameter 13 mm. BPA exhibits a retention time of about 8 minutes under these conditions, and concentrations of BPA as low as 0.5 ppb are detectable.

Quantitative standards of bis-phenol A at various concentrations are made from a 1,000 ppm stock solution of BPA in methanol by diluting the appropriate amount of stock with water. A 1.0 g sample is accurately measured and diluted with 20 ml dichloromethane. Acetone (100 mL) is gradually delivered by drops into the stirred sample, allowing a high-molecular weight compound to precipitate. After centrifugation for 10 min. at 3,000 rpm, the supernatant is concentrated to approximately 2 mL under reduced pressure (below 40° C.). The concentrated sample is washed with acetonitrile 8 mL in a measuring flask and water is added to bring the total volume to 20 mL. After filtration, the sample is analyzed using the HPLC system described above.

The water in contact with the uncoated polycarbonate will show a significant concentration of BPA, whereas the water in contact with the coated polycarbonate will show little (<100 ppb) or no detectable BPA in the samples.

In a second set of experiments, coated and uncoated polycarbonate samples are irradiated with UVA rays for one or more hours and then boiled in water as above and the water samples assayed for BPA as above. Similar results are expected, illustrating the resistance of coated polycarbonate of the present technology to reduce or eliminate leaching of BPA into the samples.

### EQUIVALENTS

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-14. (canceled)

15. An article of manufacture comprising a polymer comprising bisphenol A, wherein at least a portion of the polymer is coated with a composition comprising one or more matrix polymers having a solubility parameter of about 20 or less; and
a plurality of UV-blocking nanoparticles dispersed in the one or more matrix polymers; wherein the surfaces of the nanoparticles comprise a surface modification agent and the composition is substantially free of bisphenol A.

16. The article of manufacture of claim 15, wherein the polymer is a polycarbonate or an epoxy resin.

17. The article of manufacture of claim 15, wherein the article is a food or beverage container.

18. A method of manufacture comprising:
combining one or more matrix polymers having a solubility parameter about 20 or less, one or more solvents, and a plurality of UV-blocking nanoparticles, wherein surfaces of the nanoparticles comprise a surface modification agent, to form a coating solution or slurry substantially free of bisphenol A; and
forming a film or coating with the coating solution on a surface of a polymer comprising bisphenol A.

19. (canceled)

20. The method of claim 18, wherein the matrix polymer is a hydrocarbon polymer, a polyglycol polymer, or a fluorine-containing polymer.

21-26. (canceled)

27. The method of claim 18, wherein the nanoparticles are titanium oxide, cerium oxide, zinc oxide, tin oxide, aluminum oxide or a mixture of any two or more thereof.

28. The method of claim 18, wherein the surface modification agent comprises alkylsilane.

29-30. (canceled)

31. The method of claim 18 wherein the one or more matrix polymers are selected from the group consisting of polyethylene, polypropylene and copolymers thereof; and the nanoparticles are selected from the group consisting of titanium oxide, cerium oxide, zinc oxide, and tin oxide nanoparticles.

32. The article of manufacture of claim 15, wherein the matrix polymer is a hydrocarbon polymer, a polyglycol polymer, or a fluorine-containing polymer.

33. The article of manufacture of claim 32, wherein the hydrocarbon polymer is polyethylene, polypropylene, polyisobutylene, polycycloolefin, polybutadiene, polyisoprene, or a mixture of two or more thereof.

34. The article of manufacture of claim 32, wherein the polyglycol polymer is polytetramethylene oxide, polypropylene oxide, or a mixture of two or more thereof

35. The article of manufacture of claim 32, wherein the fluorine-containing polymer is polytetrafluoroethylene.

36. The article of manufacture of claim 15, wherein the one or more matrix polymers comprise one or more types of hydrophilic functional groups.

37. The article of manufacture of claim 15, wherein the one or more types of hydrophilic functional groups are selected from the group consisting of a carboxyl group, an amino group or a mixture of two or more thereof.

38. The article of manufacture of claim 15, wherein the nanoparticles have an absorbing edge wave length from about 350 nm to about 400 nm.

39. The article of manufacture of claim 15, wherein the nanoparticles are titanium oxide, cerium oxide, zinc oxide, tin oxide, aluminum oxide or a mixture of any two or more thereof.

40. The article of manufacture of claim 15, wherein the surface modification agent comprises alkylsilane.

41. The article of manufacture of claim 15, wherein the plurality of nanoparticles comprise about 50 wt % of the composition or less.

42. The article of manufacture of claim 15, wherein the average diameter of the nanoparticles is about 50 nm or less.

43. The article of manufacture of claim 15 wherein the one or more matrix polymers are selected from the group consisting of polyethylene, polypropylene and copolymers thereof; and the nanoparticles are selected from the group consisting of titanium oxide, cerium oxide, zinc oxide, and tin oxide nanoparticles.
